(19) United States
(12) Patent Application Publication
(10) Pub. No.: US 2009/0027499 A1
(43) Pub. Date: Jan. 29, 2009

(54) PORTABLE MULTI-MEDIA SURVEILLANCE DEVICE AND METHOD FOR DELIVERING SURVEILLED INFORMATION

(76) Inventor: David Henry Nicholl, Kansas City, MO (US)

Correspondence Address: LADI O. SHOGBAMIMU, 3303 W. 146th St, LEAWOOD, KS, 66224, US

(21) Appl. No.: 11/781,272

(22) Filed: Jul. 23, 2007

(51) Int. Cl. H04N 7/18

(52) U.S. Cl. 348/158; 348/E07.085

(57) ABSTRACT

The present invention is generally directed to a device for capturing, storing, sharing and communicating audio/video information and other related multimedia data. The present invention relates more particularly to a portable media capture device wearable by an individual such as a first responder. The device provides point-of-view information and associates the information with meta-data. The point-of-view information may be utilized for subsequent review or contemporaneous transmission to other responders or devices. The device enables surveillance or on-the-scene data captured from a user's view point to be collected and disseminated in real time to remote locations or retrieved at a later time.

The present invention is generally directed to an apparatus for capturing, storing, sharing and communicating audio/video information, multimedia data and metadata. The present invention relates more particularly to a portable media capture device wearable by an individual such as a first responder. The device is adapted to provide point-of-view information. The point-of-view information may be utilized for subsequent review or contemporaneous transmission to other responders or devices both local and remote to a scene. Surveillance or on-the-scene data captured from a user's view point may be collected, encrypted and disseminated in real time to remote locations or retrieved at a later time, from the portable user device. Remote locations may include patrol cars, other similar emergency response units, or any number of display/playing devices on a digital network.

### BACKGROUND OF THE INVENTION

Security issues and other motivations for surveillance continue to drive wide scale deployment of systems that can provide monitoring in vehicles, buildings, parking lots and other areas. Such systems provide numerous advantages as security deterrents, or evidentiary information support. Property and personal safety systems are sought after for a wide variety of applications and by a number of public and private organizations. Devices that are ordinarily used today include cameras, audio devices and biometric detection systems. These devices address the recognition and protection needs of most situations. However, sometimes a particular area at the scene of an incident has no installed surveillance equipment and is not readily accessible to the surveillance systems that are sometimes available in patrol cars or other emergency response vehicles. A person must enter the area to assess the environment and situation. It would be advantageous for other response team members to have access to visual or other data perceived by that person i.e. point-of-view data, as accurately and as quickly as possible. The point-of-view information would allow other responders to assess the situation and/or provide guidance to the person at the site. Even further, the point-of-view information would provide an accurate account of events that transpired within the viewing range of the person that was present. Current methods to obtain scene information have included attempts to equip robots with cameras, microphones and other data acquisition devices in order to get a first hand view of particular situations or environments. However, such systems suffer several shortcomings. For instance, a robot or other equipment is not able to respond and/or direct attention or focus to unanticipated scenes or situations in the same manner as a human.

It would be further advantageous, in the case of law enforcement, to have a record of the occurrence at a scene, as this could serve to vindicate an officer or suspect by providing an actual record of what took place outside the capture range of traditional surveillance systems. Audio/video and other environmental data that is perceived or acquired in person may need to be evaluated or made available to a command center or other members of a response team in order to adequately evaluate or respond to a situation. In the absence of pre-installed surveillance systems, the option currently available to emergency responders is to send in a ‘scout’ who reports back in person or over a radio. This method of information gathering could be dangerous to the scout because of the distraction involved in using a radio of the potential of drawing gun fire or attention for the observed suspect. Additionally, the scout method relies on an accurate recount by the scout of what he sees or saw. Further still, things which the scout may have observed and dismissed as immaterial may be meaningful and instrumental to a non-present responder.

As previously mentioned, surveillance measures typically include information gathering and interpretation. Information gathering begins with speculative identification about area(s) in which activities of interest are likely to occur. This is followed by providing surveillance coverage of the area. It would be advantageous to have surveillance available where and when it is needed irrespective of any prior planning. Importantly, it would be advantageous to take the surveillance to the scene of interest, without adversely impacting the person carrying such equipment or interfering with the ability of the team to communicate or participate in the interpretation of the acquired information.

As previously also mentioned, acquired information is transmitted to central monitoring locations, emergency response vehicles or to other team personnel or devices. It is usually the case that in some situations, it would be advantageous to have the ability to provide remote live monitoring by other law enforcement or emergency service agencies.

Thus, it is desirable to have a system that can acquire a wide variety of multi-media and environmental data, and secure such data so that it can be transmitted over a communication channel and/or stored for subsequent review. More specifically, it is desirable to have a system that enables storage, and transfer of audio/video information and other data, wherein said information provides a more accurate and complete impression of a particular scene or emergency situation. Even further, it would be advantageous to have the ability to share such information with other response units and personnel that are present at the scene of an incident.

It is further desirable to have a system that will provide improved point-of-view data collection using a device with a simplified user interface, and expanded communication capability.

### BRIEF SUMMARY OF THE INVENTION

The present invention is directed to sourcing, capturing and providing in a secure manner, multimedia data as perceived first hand by personnel at ‘ground zero’. In other words, point-of-view, on the scene data that may be shared with one or more other responders or command posts. A device operative for wireless transmission provides communication between a wearer and others, for real time communication.

In one aspect, the present invention is directed to a portable, small foot print, multi-media device that is wearable by an individual, for capturing audio/video data from the individual's point-of-view. The device utilizes a small camera, a microphone and a storage device, powered by a portable power source to acquire and provide multimedia data which may be recorded or transmitted to other remote devices or systems.

In another aspect, the present invention is directed to providing and associating meta-data with the captured point-of-view multi-media data.

In a further aspect, the present invention is directed to providing a device with sensors that can capture other data/conditions associated with the immediate environment of the individual in addition to the audio/video data.

In an even further aspect the present invention is directed to a simplified and unobtrusive means that is locatable by touch, for initiating and stopping the capture of information including a simplified user interface for performing other functions.

In yet another aspect, the present invention is directed to addressing the safety of the individual wearing the device, by providing tracking or positional data of the device.

In another aspect, the present invention is directed to a point-of-view device having a camera that is wearable about the head of a person so as to allow the camera to be aligned with the direction that the person is facing.

In yet another aspect, the present invention is directed to an integrated camera and recording device, or separate devices being adapted for wired or wireless communication therebetween.

### BRIEF DESCRIPTION OF THE DRAWINGS

The present invention is further described with reference to the accompanying drawings, which show a particular construction of the present invention. However, it should be noted that the invention as disclosed in the accompanying drawings is illustrated for the purpose of explanation only. The various elements and combinations of elements described below and illustrated in the drawings can be arranged and organized differently to result in constructions which are still within the spirit and scope of the present invention. Other objects and advantages of the present invention will become apparent to one skilled in the art when the description is read in conjunction with the following drawings, in which:

FIG. 1A is a perspective frontal view of an embodiment of the point-of-view device of the present invention;

FIG. 1B is a perspective rear view of the device of the FIG. 1A;

FIG. 2 is an illustrative diagram of an environment in which the device of the present invention would be utilized; and

FIG. 3 is an illustrative block diagram of exemplary components of the device of the present invention.

### DETAILED DESCRIPTION OF INVENTION

The present invention is directed to a multi-media monitoring and surveillance device wearable by an individual to provide first hand information about an environment from the individual wearer's point-of-view. The device is operable in conjunction with one or more data collection stations, remote viewing stations, communication devices and other security related components. More specifically, the device of the present invention provides collection, communication and sharing of informational items as experienced and/or perceived by an individual at a scene of interest. A wearable camera and a microphone that capture surrounding video and sounds provide real-time acquisition of the wearer's environment for sharing or subsequent review of the experience. It should be noted that the wearable camera may be a visual, infrared, thermal or other type of camera. The portable monitoring/surveillance device is embodied in a combination of hardware and software components.

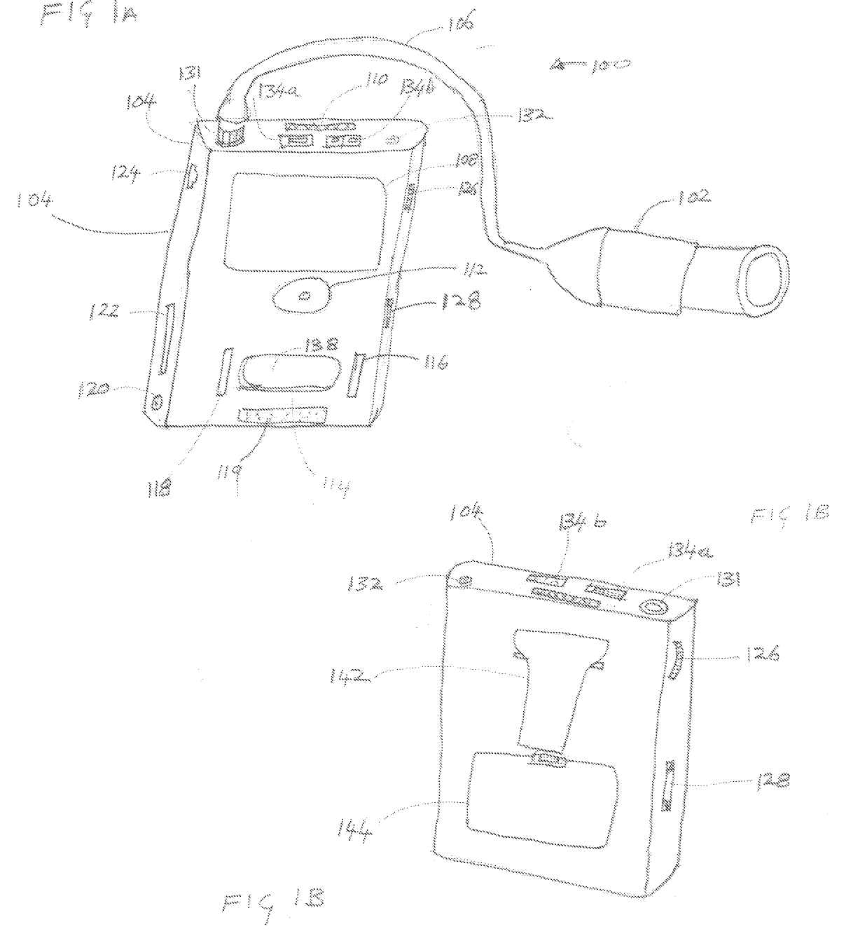

The present invention is best described with reference to the drawing figures, wherein FIGS. 1A and 1B illustrate an embodiment of the multimedia point-of-view device 100 of the present invention. As would be appreciated by one skilled in the art, the components shown in the drawing figure or the proximity or location of any one component to one another, is merely illustrative and is not intended to limit the application or scope of the present invention to the illustrated components or illustrated locations. Later portions of this document will make apparent the myriad of components, interconnection and configurations that are possible for the device 100. The device 100 is powered by one or more standard batteries and may be powered by other light weight and/or portable power sources.

As shown in FIG. 1A, the device 100 includes means to acquire multimedia data and have the user review the data. The device 100 includes a camera 102 operatively connected to a video port 131 on a base unit 104 by a flexible connector cable 106. The base unit 104 having a display screen 108, a microphone 110, a start/stop button 114, a forward button 116, a reverse button 118 and a speaker 119. The display screen 108 operative to provide user review of previously captured video or to provide interaction between the user and the device 100. The display screen 108 may provide simultaneous/real time display of video as it is captured by the camera 102. The speaker 119 operative to reproduce capture audio. In an embodiment of the invention, video or audio information are wirelessly provided to the device 100 from a wireless camera or microphone. An external wired microphone may also be connected to the base unit 104 via audio port 132.

Information obtained by the device 100 may be stored in one or more conventional methods to a storage medium thus allowing the field user to capture information for extended periods of time. The device 100 includes an SD card slot 26 for receiving a Secure Digital (SD) memory card for use as data storage. The device 100 may also utilize other storage mediums or technologies.

The start/stop button 114 is operative to initiate the recording functions of the device 100 or alternatively stop the recording functions. The start/stop button 114 includes a contact surface 138 sized, shaped and disposed on the device 100 so as to be discernable to a user by touch, thus enabling quick location and identification. In one embodiment, the contact surface 138 of the start/stop button 114 or a portion thereof is spaced from the adjacent planar surface of the base unit 104, so as to allow a field operator to quickly locate the button by feeling for a raised or lowered contact surface 138. In another embodiment of the invention, the contact surface 138 is textured to allow the field operator to identify the start/stop button 114 by touch. More specifically the start/stop button 114 presents a reticulated contact surface 138. In a further embodiment, the start/stop button 114 may be illuminated at the option of the field operator, to allow the operator to visually locate it.

The device 100 includes means for navigating a menu or other method for selecting functions or options available on the device 100 such as, the replay of a recording, configuration setting, personal preferences etc. Examples of such means include a menu scroll 112, thumb wheel 126 and volume control 128.

The device 100 further includes interface ports, for connection to other devices, components and systems, namely a Universal Serial Bus (USB) port 124, an audio input port 132 and auxiliary input ports 134a, 134b. Other port types as needed or technologically available maybe provided so as to enable or support other types of connections or communications. For example, a thumb print scanner or other biometric input device may be utilized.

The USB port 124 may be used to provide information to the device 100 or extract information from the device 100. For example, the USB port 124 may be used to communicate configuration data, software updates, end-user identification or other relevant data. Information provided via the USB port 124 is recordable as metadata, which may be associated with acquired point-of-view data. The Auxiliary Input ports 134a, 134b are provided to facilitate the connection of other devices or sensors to the device 100. For example, a temperature sensor may be connected to input port 134a, so as to provide environmental temperature information during the operation of the device 100. In other words, when recording is activated, environmental temperature data would also be acquired from the temperature sensor, recorded and processed similar to the audio/video data.

FIG. 1B illustrates the rear view of the device 100. A clip 142 and a battery compartment cover 144 are included on the rear of the base unit 104. As shown, the clip 124 such as one found ordinarily for attaching pagers, cell phones or other devices is provided to allow the device 100 to be attached to a belt, clothing waistline or other items as desired by the field user. As would be appreciated by one skilled in the art, the clip 142 is one of a variety of mechanisms or methods for locating the device 100 on a garment, tool, other apparel or other parts of a person or device. Such other similarly purposed mechanisms or methods are contemplated and within the scope of the device 100 of the present invention. The battery compartment cover 144 may be shaped or located differently on the base unit 104. The battery compartment cover 144 may also be absent, such as in an embodiment where the base unit 104 is equipped with a long life power source that does not require typical end-user service.

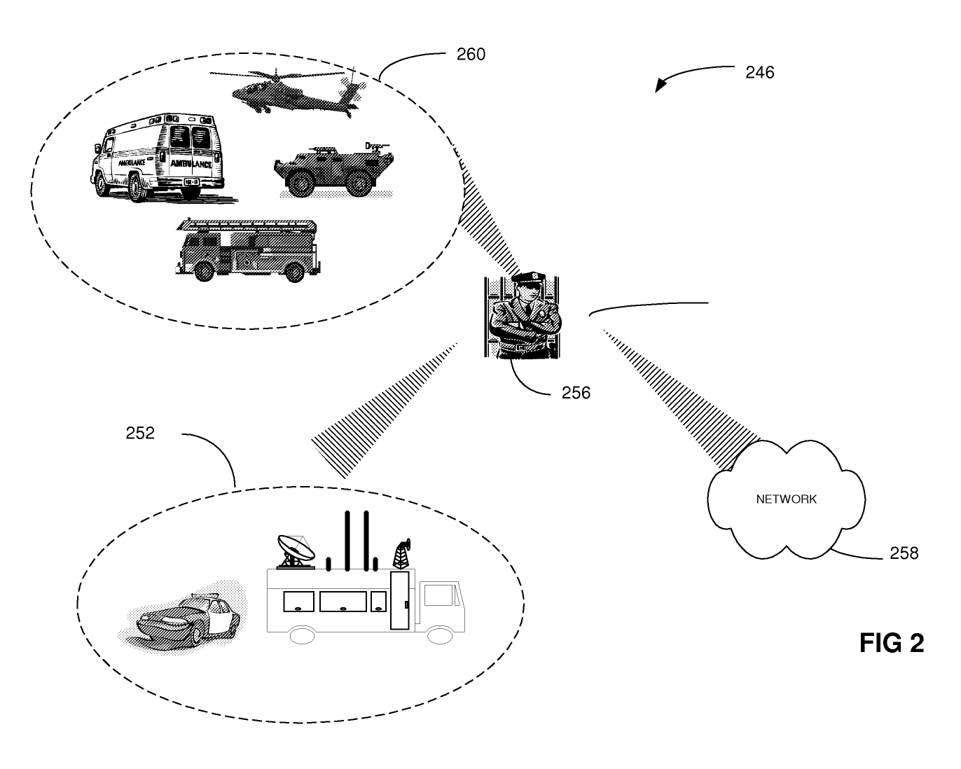

Advantages and other novel aspects of the invention will become more apparent following a discussion of an operational environment for the device 100 as illustrated in FIG. 2. The device 100 is utilized to capture and disseminate multimedia data at an emergency scene 246. As would be appreciated by one skilled in the art, the illustrated components and their proximity to one another in the scene 246 is merely exemplary and is not intended to limit the application or scope of the present invention to the illustrated elements or connectivity schemes.

As shown, a scene of interest or subject area 246 may have police vehicles, command post vehicles or other similar mobile units, which will generally be referred to as a first response unit 252 herein. The subject area 246 may be a building, a bus, train, airplane or any other confined area that is only readily accessible by a person, special device or robot, any of which will be generally referred to herein as field personnel 256. The first response unit 252 may be equipped to receive, display or forward captured data from the subject area 246. However, as previously stated, this captured data is limited to the visible/audible range of the first response unit 252. Conversely, field personnel 256 wearing the device 100 of the present invention is able to take surveillance to a higher or more intimate level, by accessing the interior of the subject area 246, thus broadening the visible/audible range of surveillance. Video, audio and other environmental data as perceived first-hand by the field personnel 256 is captured and otherwise processed by the device 100, as previously described. The captured information may be communicated to other standalone devices or to a network 258 that is accessible by a plurality of systems and devices. The captured information may also be encrypted for added security. The network 258 may include equipment that is located within vehicles or other remote locations, or worn by other personnel.

The term captured data, unless specifically identified otherwise, is used interchangeably herein to mean any data that originates from the device 100. In other words, captured data refers to a real-time feed, data that was previously stored, recorded or otherwise manipulated by the sourcing device 100. It should be understood that the system and method of the present invention is applicable to a variety of multimedia information and data types, all of which are within the scope of the present invention.

In some instances, in response to an emergency situation, it is likely that there may be multiple responding agencies and units. For example, in addition to the first response unit 252, there may also be several other responding personnel, fire trucks, ambulances, swat team vehicles, helicopters and a command post unit. The command post may be a mobile post, a police station or any building utilized as a communication hub and may be located several miles away from the scene 246. These other responding personnel are collectively referred to in this document as ‘other response unit’ 260. As would be appreciated by one skilled in the art, any one or more of the other response units 260 could belong to a different number of responding agencies, including the police department, the fire department, National Guard or any Federal agencies.

The system and method of the present invention enables and facilitates communication between the device 100 of field personnel 256 and the one or more other response units 260. More specifically, the present invention provides for the sharing of point-of-view data from the field personnel 256, among the various other response units 260. Communication between the device 100 and each of the other response units 260 may occur over a secure wireless connection or involve the direct physical connection of the device 100 to particular response units 260 or to the network 258.

In operation, communication from the device 100 is enabled when the appropriate security criteria and communication initiation procedures have been satisfied and when the intended other participant, i.e. other response units 260, is within proximity of the communication radius for an applicable network type. A connection may be established between a first device 100 and a second device 10 or at least one other response unit 260 for transmission of video, audio or other data, including environment sensor data or meta-data. The meta-data that is transmitted from the device 100 may include an identification code that is sent with the images or other data to identify the sourcing device 100 and/or provide other information regarding the field personnel 256.

Having described the operational environment for the implementation of the present invention, the specific details of the components utilized in one embodiment of the present invention will next be discussed. The details include a description of the components and methodology for providing point-of-view multi-media data.

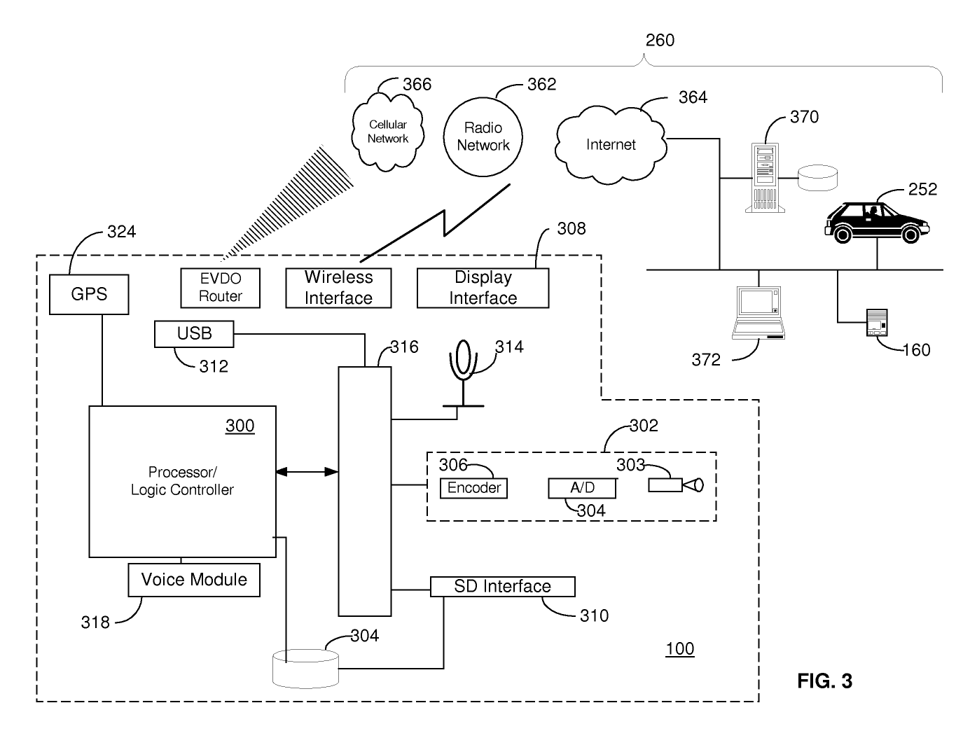

FIG. 3 illustrates exemplary components for the multimedia device 100. As shown, the device 100 comprises a processor/logic unit 300, a capture device 302, storage medium 304 and a variety of interface components. The capture device 302 may include a CCD camera 303, an Analog/Digital (A/D) converter 304, and encoder/packetizer 306. As would be appreciated by one skilled in the art, the A/D converter 304 or encoder 306 are used in conjunction with a camera having an analog output, and would not be required when using an integrated image sensor. A display interface 308, an SD card interface 310, a USB interface 312 and a microphone 314, are operably connected to an I/O interface 316. As would be appreciated by one skilled in the art, the I/O interface 316 may be physically separate from or incorporated with the processor unit 300. The capture device 302 acquires video images utilizing any one of a number of known methodologies. A portable video camera or other multi-media capture device such as a cell phone, PDA or the like may be utilized as a capture device 302.

In operation, field personnel 256 initiate event capture i.e. video, audio, environmental data, and meta-data logging, by activating a start function. In one embodiment of the present invention, the field personnel utilize the single start/stop button 114 to both initiate and end event capture. In another embodiment of the present invention, event capture is initiated and ended by vocal commands issued via the built-in microphone 110, a remote microphone or other similar audio device. A voice recognition module 318 generates the appropriate signaling to the logic processor 300 of the device 100 to initiate or terminate event capture.

The capture device 302 may be an integrated sensor or as shown may comprise an analog camera 303 coupled to the A/D converter 304 to provide the captured image in a digital format. The digitized image data is then encoded and packetized by an encoder 306 into secure packets for storage to the storage medium 304. Audio data and other environmental data are also processed and stored to the storage medium 304, along with meta-data.

A display component 310 facilitates display of captured video and other data onto the display screen 108. As previously mentioned, the captured event data can also be transmitted to a remote device for concurrent display with the local display. End user configuration settings in the device 100 determine the particular mode of operation, with respect to local functions and communication with remote devices.

The device 100 is adapted to communicate with a variety of networks 258. A cellular interface module 320 provides communication over traditional cellular networks. A radio module 322 provides communication via wireless radio links. Other wireless communications such, blue tooth, wireless LAN are also possible by incorporating the appropriate transceivers. A communication switching means 340 included in the device 100 provides network selection for the dissemination of the event data. One or more networks 258 may be selected on the basis of proximity of the participating devices or other criteria such as security, broadcast needs and so on. Other interface modules may be utilized to provide communication on a variety of networks including USB, Ethernet, a proprietary network, etc.

The term networks 258 is used interchangeably herein to mean the entire collection of networks as shown or any segment thereof i.e. Radio network 362, Wireless WAN (not shown), Internet 364, cellular network 366, and mesh or local network 368, unless specifically identified otherwise. The network 258 may include a server 370 in operative communication with the device 100, first response unit 252, other remote response units 260 and any number of other ‘client’ devices. The communication server 370 may serve as a central repository for data obtained from the device 100. The server 370 may also operate in anyone of a number of roles typical of a server in a traditional client-server environment.

It is implicit that all reference to connectivity and access to event data captured by device 100 require that any appropriate security authentication been duly satisfied.

In a further embodiment of the present invention, the device 100 includes a GPS component 324, which enables tracking of the device and thus provides a level of safety for the field personnel 256, who may be quickly located in the event of some emergency.

The features, use and novelty of the present invention may best be understood by considering an exemplary situation and instance in which the various components would be advantageous.

Consider a hostage situation or other similar standoff, in a mall or other structure having multiple corridors, rooms, stairwells, floors, exits and ground areas. It would be advantageous for law enforcement or any other intervening body to have the ability to properly assess the site, and gain as much insight as possible into the current state of affairs. It is likely that such a situation will involve multiple agencies that would also need similar or related information. Device 100 of the present invention enables one or more officers to enter the building or grounds and provided point-of-view data to other responding units 260. Field personnel 256 would not have to rely on just his memory to describe what he experienced—visually, audibly or otherwise, the information would be recorded for later or simultaneous review. The device 100 enables the delivery and review of detailed and quality site informational data from the point-of-view of field personnel 256, which can include images, sounds, and other environmental information. This detailed and quality data lends itself to collaboration among the various agencies by enabling simultaneous and timely access to the same information using the system and methods earlier described. Privacy and the integrity of the site related data is maintained by security measures implemented in the system.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This aspect is contemplated by and is within the scope of the claims. Since many possible embodiments of the invention may be made without departing from the scope thereof, it is also to be understood that all matters herein set forth or shown in the accompanying drawings are to be interpreted as illustrative and not limiting. Functions and features described herein may be implemented in hardware or software, or any combination of both hardware and software, without departing from the scope of the invention.

Various aspects and functionality of the present invention may be implemented in a variety of combination of hardware and/or software. Different programming techniques can be employed to achieve the objects of the invention without departing from the scope thereof. Steps, operations and computations while presented in a particular order may be re-ordered for different embodiments of the invention. Communication of information as described herein may be accomplished by methods involving broadcast operations, polling, point-to-point, or other communication protocols.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

What is claimed is:

1. A user wearable device for providing point-of-view multi-media information from a scene, the device comprising:
a first component for providing images observable by the user;
a second component for providing sounds from the scene;
a storage medium; and
a logic device, operatively connected to said storage medium,
said first component and second component operatively connected to said logic device to provide said images and sounds;
said logic device adapted to associate one or more meta-data items with said images and sounds to provide said point-of-view multi-media information;
wherein said point-of-view multi-media information is provided to said storage medium;
said storage medium being accessible to retrieve said multi-media information.

2. The device of claim 1 further comprising a start/stop signaling component for activating and deactivating the capture of said point-of-view multi-media information at the scene.

3. The device of claim 2 further comprising a timing device, said timing device providing a time stamp and wherein said one or more meta-data items is said time stamp.

4. The device of claim 3 further comprising a global positioning device, said global position device providing location information pertaining to the user wearable device, wherein said one or more meta-data items is said location information.

5. The device of claim 3 further comprising an environmental sensor, said environmental sensor providing a data reading of environmental condition and wherein said one or more meta-data items is said data reading.

6. The device of claim 2 wherein said first component is a ccd camera.

7. The device of claim 2 wherein said second component is a microphone.

8. The device of claim 7 wherein said microphone is wireless.

9. The device of claim 3 further comprising a cellular module for wireless communication of information stored on said recording medium.

10. The device of claim 2 wherein said start/stop signaling component is a voice recognition module, said module providing signals to the device in response to one or more voice commands, whereby the device capture of point-of-view multi-media information is activated/deactivate by said one or more voice commands.

11. The device of claim 2, wherein said first component is wearable about the head of the user so as to allow images to be captured from the direction the user is facing.

12. A user wearable device for providing point-of-view multi-media information at a scene, the apparatus comprising:
a camera unit for providing visual images observable from the user's point-of-view of the scene; and
a base unit, said base unit comprising:
an audio capture device;
a display screen;
processing means;
a storage medium; and
means for initiating provisioning of the point-of-view multi-media data;
said camera unit, operably connected to said base unit to provide said visual images to said processing means and said audio capture device providing audio information from the scene, when said initiating means is triggered a first time;
said processing means receiving said visual images and providing one or more meta-data items for association with said visual images and said audio information, and providing resulting data to said storage medium, until said initiating means is triggered a second time;
said display screen operably connected to said processing means and said storage medium to display said resulting data.

13. The device of claim 12 further comprising a transceiver module interconnected to said processing means, to provide said multi-media information to a remote device.

14. The apparatus of claim 12, wherein said display screen provides said resulting data directly from said processing means.

15. The device of claim 12, wherein said display screen provides interactive user prompts so as to allow the user to operate the device.

16. The device of claim 12, wherein said one or more meta-data items is a time stamp.

17. The device of claim 12, wherein said one or more data items is location information.

18. The device of claim 12, wherein said one or more meta-data items is environmental condition data.

19. The device of claim 12, wherein said audio capture device is a wireless microphone.

20. The device of claim 13, wherein said transceiver module is a cellular module for wireless communication of the resulting data to said remote device on a cellular network.

21. The device of claim 13, wherein said transceiver module is operative to communicate the resulting data to said remote device on an Ethernet network.

22. The device of claim 13, wherein said initiating means responds to one or more user inputs.

23. The device of claim 22, wherein said one or more user inputs is one or more voice commands.
